(19) United States
(12) Patent Application Publication
(10) Pub. No.: US 2007/0200986 A1
(43) Pub. Date: Aug. 30, 2007

(54) Contrast ratio and viewing angle improvement for a TN- LCD

(76) Inventor: Hiap L. Ong, Northborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/648,169

(22) Filed: Dec. 29, 2006

Related U.S. Application Data
(60) Provisional application No. 60/755,107, filed on Dec. 29, 2005.

(51) Int. Cl. G02F 1/1335

(52) U.S. Cl. 349/117; 349/11

(57) ABSTRACT

A liquid crystal display includes a liquid crystal layer between a first substrate and a second substrate, at least one first-type optical compensation layer over the liquid crystal layer, and at least one polarizer layer over the first-type optical compensation layer. The liquid crystal layer has a birefringence liquid crystal material. The first-type optical compensation layer includes a negative birefringence material. The optical axis of the first-type optical compensation layer is substantially parallel to a plane of either of the first substrate or the second substrate throughout the the layer. A liquid crystal display is prepared by forming a liquid crystal layer as described above, forming at least one first-type optical compensation layer as described above, and forming at least one polarizer layer over the first-type optical compensation layer.

### RELATED APPLICATION

This application claims the benefit of U.S. Provisional Application No. 60/755,107, filed on Dec. 29, 2005, the entire teachings of which are incorporated herein by reference.

### BACKGROUND OF THE INVENTION

The market for liquid crystal displays (LCDs) is increasing rapidly, especially in areas of high performance LCDs and hand-held mobile device applications. These applications generally require high resolutions. high contrast levels. wide symmetrical viewing angles and fast response times. In addition, high contrast levels with respect to different viewing angles, gray-scale inversion, colorimetry and optical response of an LCD are important factors of high quality LCDs. Most conventional LCDs are 90° twisted-nematic liquid crystal displays (TN LCDs). The drawbacks of these conventional TN LCDs are low contrast and narrow viewing angles (e.g., ±40° horizontally and −15° and +30° vertically). For LCD monitor and TV applications, low applied voltage and low power requirements are not as important as they are for LCDs employed in mobile device applications. For mobile device applications, a low applied voltage (typically 2-4 volts, as opposed to 5-6 volts for the LC monitor and TV) and low power consumption are typically used, and yet high contrast levels and wide viewing angles are required.

Therefore, there is a need for developing new TN LCDs, addressing one or more of the aforementioned problems, especially for TN LCDs having a high contrast ratio at a low applied voltage.

### SUMMARY OF THE INVENTION

The invention is directed to an LCD, employing a liquid crystal (LC) material, and to a method of preparing the LCD. An LCD of the invention includes an LC layer between a first substrate and a second substrate; at least one first-type optical compensation layer over the liquid crystal layer; and at least one polarizer layer over the first-type optical compensation layer. The LC layer includes a birefringence LC material. The first-type optical compensation layer includes a negative birefringence material. The optical axis of the first-type optical compensation layer is substantially parallel to a plane of either of the first substrate or the second substrate throughout the first-type optical compensation layer. The method of forming the LCD includes the steps of: a) forming an LC layer as described above between a first substrate and a second substrate; b) forming at least one first-type optical compensation layer as described above over the LC layer; and c) forming at least one polarizer layer over the first-type optical compensation layer.

The first-type optical compensation layer, having negative birefringence, a low retardation value of, for example, between about −1 and about −50 nm and an optical axis parallel to a plane of the first substrate or the second substrate, can significantly improve the contrast ratio of an LCD at a relatively low applied voltage, for example, between about 2 volts and about 4 volts. With the combination of wide-viewing-angle compensation films, the negative birefringence optical compensation layer of the invention can improve both the contrast ratio and viewing angle of an LCD of the invention at a relatively low applied voltage. The first-type optical compensation layer employed in the invention can also improve the contrast ratio of both normal and oblique incident light. It can compensate residual (intermediate on-state between full-on- and off-states) LC birefringence, as compared to the LC birefringence in the full-on state, to thereby improve the contrast ratio, especially in LCDs operated at low voltages.

Without being bound to a particular theory, it is believed that, in the LCDs of the invention, the first-type optical compensation layer can improve normal incident and oblique angle contrast ratios (CR), and the second-type optical compensation layer can improve a normal incident and relatively-wide oblique angle contrast ratios.

The LCDs of the invention can be used for a variety of applications, including electronic viewfinders for camcorders and digital cameras, and portable video eyewear to watch movies, music video and sporting events, and playing games, such as head-mounted displays, devices for watching DVDs or digital RV, mobile computing, and playing 3-D video games on lightweight eyewear systems.

### BRIEF DESCRIPTION OF THE DRAWINGS

FIG. 1A is a schematic drawing of one embodiment of the LCDs of the invention.

FIG. 1B is a schematic drawing showing an orientation of optical axes of first-type optical compensation layers employed in one embodiment of the TN LCDs of the invention with LCs clock-wise twisted (left-handed) in off-state.

FIG. 1C is a schematic drawing showing the relationship between the orientation of optical axes of first-type optical compensation layers and the orientations of LCs at the top and bottom parts of one embodiment of the TN LCDs of the invention with LCs clock-wise twisted (left-handed) in off-state.

FIG. 1D is a schematic drawing showing an orientation of optical axes of first-type optical compensation layers employed in one embodiment of the TN LCDs of the invention with LCs clock-wise twisted (right-handed) in off-state.

FIG. 1E is a schematic drawing showing relationship between the orientation of optical axes of first-type optical compensation layers and the orientations of LCs at the top and bottom parts of one embodiment of the TN LCDs of the invention with LCs clock-wise twisted (right-handed) in off-state.

FIG. 1F is a schematic drawing showing general relationship between the orientation of optical axes of first-type optical compensation layers and the orientations of LCs at the top and bottom parts of one embodiment of the TN LCDs of the invention with a twist angle of θ and clock-wise twisted (left-handed) direction.

FIGS. 2A and 2B are schematic drawings showing two different embodiments of the LCDs of the invention.

FIG. 3A shows a drive-scheme architecture that can be employed in the LCDs of the invention.

FIG. 3B is a timing diagram that illustrates operation of the ac-coupled drive scheme of FIG. 3A.

FIG. 4 shows a block diagram of an LCD of the invention.

FIG. 5 shows a head-mounted LCD of the invention.

FIG. 6 is a graph showing calculated optical transmission versus voltage to simulate one embodiments of the twisted-nematic (TN) LCDs of the invention in a crossed-polarizer geometry, having first-type optical compensation layers (star: optical compensation layer having −1 nm optical retardation; filled diamond: optical compensation layer having −5 nm optical retardation; cross: optical compensation layer having −10 nm optical retardation; filled triangle: optical compensation layer having −20 nm), and to simulate a comparative TN LCD without the first-type optical compensation layers (filled square: Normal).

FIG. 7 is a graph showing calculated optical contrast ratios versus voltage to simulate one embodiments of the TN LCDs of the invention in a crossed-polarizer geometry, having first-type optical compensation layers (star: optical compensation layer having −1 nm optical retardation; filled diamond: optical compensation layer having −5 nm optical retardation; cross: optical compensation layer having −10 nm optical retardation; filled triangle: optical compensation layer having −20 nm), and to simulate a comparative TN LCD without the first-type optical compensation layers (filled square: Normal).

FIG. 8A is a graph showing calculated contrast ratios of horizontal viewing zone versus viewing angle (−80 to +80 degrees) at an applied voltage of 3.1 volts to simulate: a TN LCD of the invention in a crossed polarizer geometry having first-type optical compensation layers with −15 mn retardation (identified as “A-plate” in FIG. 8A) and conventional, wide-viewing-angle compensation layers (identified as “WVA” in FIG. 8A) available from Fuji Photo Film Co. as second-type optical compensation layers (filled diamond); a TN LCD in a crossed polarizer geometry having WVA as second-type optical compensation layers (filled triangle); and a control TN LCD without any optical compensation layers (filled square: prior art).

FIG. 8B shows the data of FIG. 8A with an expansion of viewing angle scale (−20 to +20 degrees).

FIG. 9A is a graph showing calculated contrast ratios of vertical viewing zone versus viewing angle (−80 to +80 degrees) at an applied voltage of 3.1 volts to simulate: a TN LCD of the invention in a crossed-polarizer geometry having first-type optical compensation layers with −15 nm retardation (identified as “A-plate” in FIG. 9A) and conventional, wide-viewing-angle compensation layers (identified as “WVA” in FIG. 9A) available from Fuji Photo Film Co. as second-type optical compensation layers (filled diamond); a TN LCD in a crossed-polarizer geometry having the WVAs as second-type optical compensation layers (filled triangle); and a control TN LCD without any optical compensation layers (filled square).

FIG. 9B shows the data of FIG. 9A with an expansion of viewing angle scale (−20 to +20 degrees).

FIG. 10A is a graph showing calculated contrast ratios of diagonal viewing zone (45-degree/225-degree) versus viewing angle (−80 to +80 degrees) at an applied voltage of 3.1 volts to simulate: a TN LCD of the invention in a crossed polarizer geometry having first-type optical compensation layers with −15 nm retardation (identified as “A-plate” in FIG. 10A) and conventional, wide-viewing-angle compensation layers (identified as “WVA” in FIG. 10A) available from Fuji Photo Film Co. as second-type optical compensation layers (filled diamond); a TN LCD in a crossed-polarizer geometry having the WVAs as second-type optical compensation layers (filled triangle); and a control TN LCD without any optical compensation layers (filled square).

FIG. 10B shows the data of FIG. 10A with an expansion of viewing angle scale (−20 to +20 degrees).

FIG. 11A a graph showing calculated contrast ratios of diagonal viewing zone (135-degree/135-degree) versus viewing angle (−80 to +80 degrees) at an applied voltage of 3.1 volts to simulate: a TN LCD of the invention in a crossed polarizer geometry having first-type optical compensation layers with −15 nm retardation (identified as “A-plate” in FIG. 11A) and conventional, wide-viewing-angle compensation layers (identified as “WVA” in FIG. 11A) available from Fuji Photo Film Co. as second-type optical compensation layers (filled diamond); a TN LCD in a crossed-polarizer geometry having the WVAs as second-type optical compensation layers (filled triangle); and a control TN LCD without any optical compensation layers (filled square).

FIG. 11B shows the data of FIG. 1A with an expansion of viewing angle scale (−20 to +20 degrees).

FIG. 12 is a calculated contrast ratio contour plot at an applied voltage of 3.1 volts to simulate a control TN LCD under a crossed polarizer without any optical compensation layer (prior art).

FIG. 13 is a calculated contrast ratio contour plot at an applied voltage of 3.1 volts to simulate a TN LCD under a crossed-polarizer geometry with a conventional, wide-viewing-angle compensation layers (WVA) available from Fuji Photo Film Co. as second-type optical compensation layers (prior art).

FIG. 14 is a calculated contrast ratio contour plot at an applied voltage of 3.1 volts to simulate a TN LCD of the invention under a crossed polarizer with first-type optical compensation layers (−15 nm retardation) and a conventional, wide-viewing-angle compensation layers (WVA) available from Fuji Photo Film Co. as second-type optical compensation layers.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

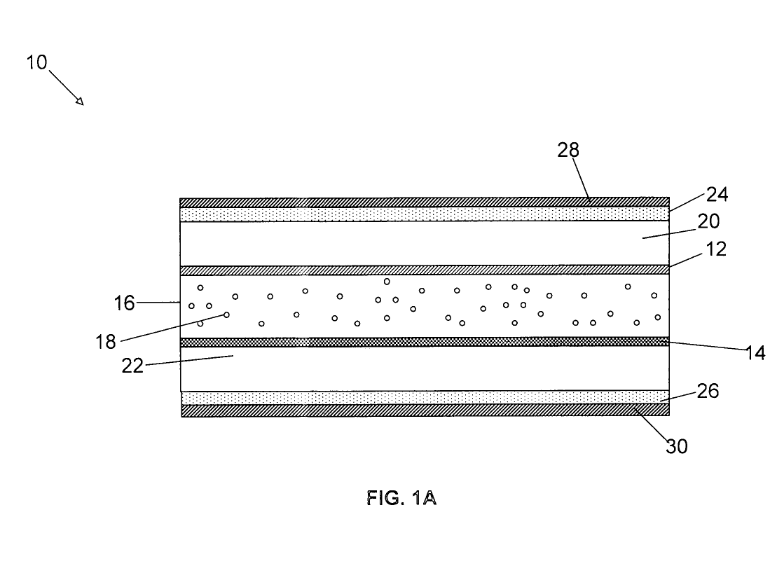

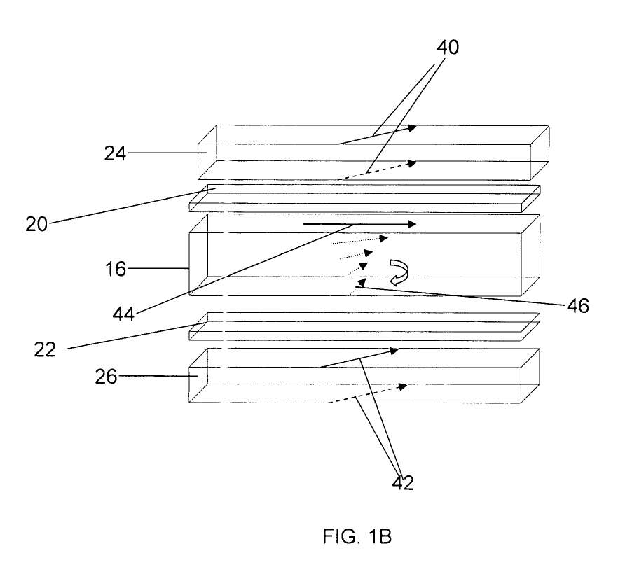

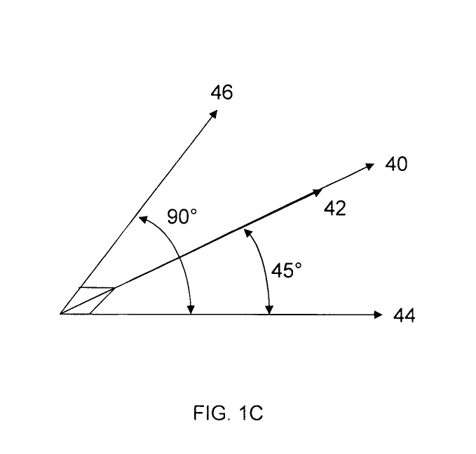

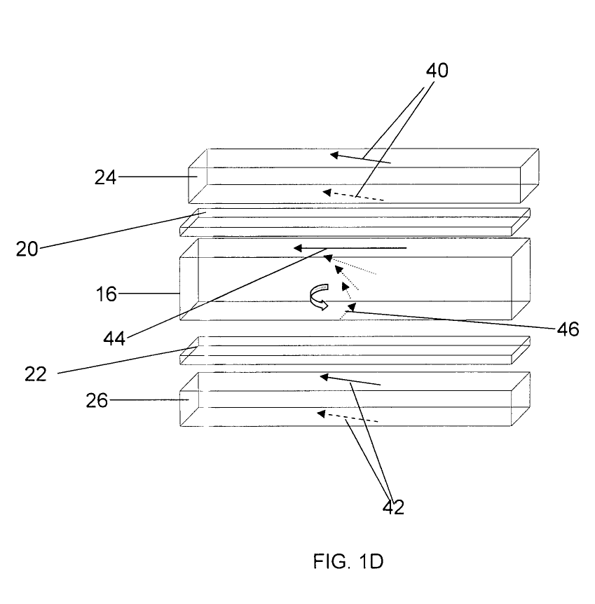

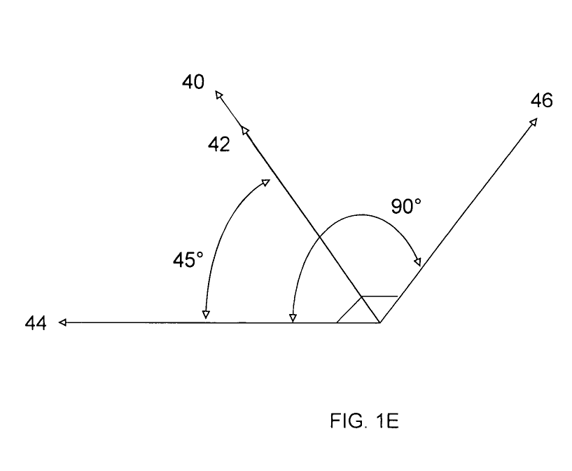

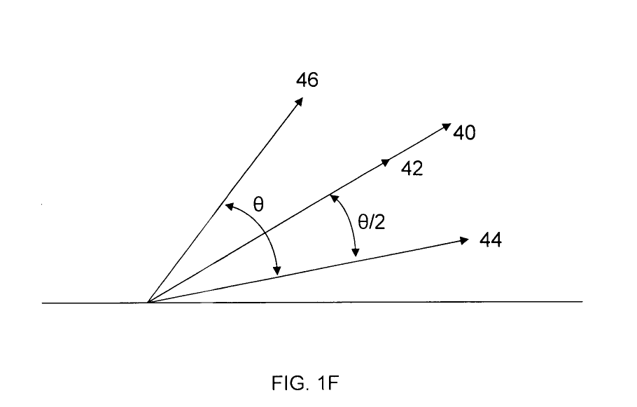

FIG. 1A shows a cross-sectional view of LCD 10 of the invention. As shown in FIG. 1A, LCD 10 includes LC layer 16 between first substrate 20 and second substrate 22. LC layer 16 includes birefringence LC material 18. LCD 10 also includes first-type optical compensation layers 24 and 26, respectively, between LC layer 16 and polarizer 28, and LC layer 16 and polarizer 30. Although two first-type optical compensation layers are shown in FIG. 1, in one embodiment, one first-type optical compensation layer, either first-type optical compensation layer 24 or 26, is employed in the invention. Alternatively, more than two first-type optical compensation layers (e.g., as a stack (not shown)) can also be used in the invention.

In FIG. 1A, LCD 10 further includes common electrode 12 between LC layer 16 and first substrate 20, and pixel electrode 14 between LC layer and second substrate 22. Preferably, LCD 10 includes a plurality of pixel electrodes 14.

In some embodiments, first-type optical compensation layers 24 and 26 each independently include a negative birefringence material, and LC layer 16 includes positive birefringence LC material 18, preferably positive birefringence, twisted-nematic (TN) LC material. In other embodiments, alternatively, first-type optical compensation layers 24 and 26 each independently include a positive birefringence material, and LC layer 16 includes negative birefringence LC material 18. The birefringence material employed in first-type optical compensation layers 24 and 26 can be an uniaxial birefringence material or biaxial birefringence material.

The optical axis of compensation layer 24 is substantially parallel to a plane of first substrate 20 throughout compensation layer 24, and the optical axis of compensation layer 26 is substantially parallel to a plane of second substrate 22 throughout compensation layer 26 (i.e. homogeneously parallel oriented). For example, the orientation of the optical axis of each of compensation layers 24 and 26 is substantially the same at any points throughout the layer.

Each of the optical axes of compensation layers 24 and 26, which are substantially parallel to a plane of first substrate 20 and to a plane of second substrate 22, respectively, can be at any angle. In a preferred embodiment, the optical axes of compensation layers 24 and 26 independently have substantially the same orientation as the middle orientation between twisted directions of the top and bottom LCs of LC layer 16, as shown in FIGS. 1B-1F. FIGS. 1B and 1C show one embodiment of a 90-degree TN LCD of the invention with LCs clock-wise twisted (left-handed) in off-state. FIGS. 1D and 1F show one embodiment of a 90-degree TN LCD of the invention with LCs anti-clock-wise twisted (right-handed) in off-state. FIG. 1F shows an orientation of the optical axes of compensation layers 24 and 26 with respect to the orientations of LCs at the top and bottom of θ-degree TN LCDs of the invention.

In a specific embodiment, as shown in FIGS. 1B-1E (for clarity, only LC layer 16, first substrate 20, second substrate 22 and compensation layers 24, 26 are shown), optical axis 40 of compensation layer 24 is oriented parallel to a plane of first substrate 20 homogeneously throughout compensation layer 24, and at about 45-degree deviated from LC orientation 44 of LC layer 16. Similarly, optical axis 42 of compensation layer 26 is oriented parallel to a plane of second substrate 22 homogeneously throughout compensation layer 26, and at about 45-degree deviatated from LC orientation 46 of LC layer 16. In a more specific embodiment, as shown in FIGS. 1B and 1C, LCD 10 of the invention has LC 18 twisted clockwise in off state. In this embodiment, if LC 18 at a bottom part of LC layer 16 (close to second substrate 22) is in an orientation, for example, at x -axis (or 0-degree), and LC 18 at a top part of LC layer 16 (close to first substrate 20) is in an orientation, for example, at negative y-axis (or −90-degree), then the optical axis of first-type compensation layers 24 and 26 is at about −45-degree. In another more specific embodiment, as shown in FIGS. 1D and 1F. LCD 10 of the invention has LC 18 twisted anti-clockwise in off state. In this embodiment, if LC 18 at a bottom part of LC layer 16 (close to second substrate 22) is in an orientation, for example, at x -axis (or. 0-degree), and LC 18 at a top part of LC layer 16 (close to first substrate 20) is in an orientation, for example, at positive y-axis (or +90-degree), then the optical axis of first-type compensation layers 24 and 26 is at about +45-degree.

As used herein, the phrase “substantially parallel to a plane of first substrate 20 or second substrate 22,” with respect to the optical axis of first-type optical compensation layer 24 or 26, means that the optical axis is parallel to a plane of first substrate 20 or second substrate 22 with less than about 10-degree deviation. In a preferred embodiment, the optical axis of first-type compensation layer 24 or 26 is parallel to a plane of substrate 20 or 22 with a deviation less than about 5-degree, such as less than about 3-degree or less than about 1-degree.

The term “optical axis” is used herein as used in the art, referring to the direction along which waves normally propagate with the same velocity in a birefringence material. When light has a normal incidence to the birefringence material, an ordinary ray goes through, undisplaced, while an extraordinary ray, after traversing the birefringence material, emerges parallel to the ordinary ray, but, in general, displaced from it. For materials having negative birefringence, the refractive index of the ordinary ray is greater than that of the extraordinary ray.

In a preferred embodiment, first-type optical compensation layers 24 and 26 each independently have an optical retardation value of between about −1 nm and about −50 nm, such as between about −1 nm and about −20 nm. An optical retardation value (Re) of a layer or film is represented by the following equation (1):
Re=(nₑ−nₒ)x d (1)
where d is the thickness of the layer or film, nₑ and nₒ are, respectively, ordinary refractive index and extraordinary refractive index of light passes through the layer or film. The term (nₑ−nₒ) is generally called birefringence of the material. A positive birefringence generally refers to (nₑ−nₒ)>0, and a negative birefringence generally refers to (nₑ−nₒ)<0.

In the invention, the thickness of first-type optical compensation layers 24 and 26 can be adjusted depending upon nₑ and nₒ of compensator materials of first-type optical compensation layers 24 and 26, or vice versa to obtain the desired optical retardation value, such as between about −1 nm and about −50 nm. Typically, the thickness of first-type optical compensation layers 24 and 26 are each independently in a range of between about 5 nm and about 20,000 nm.

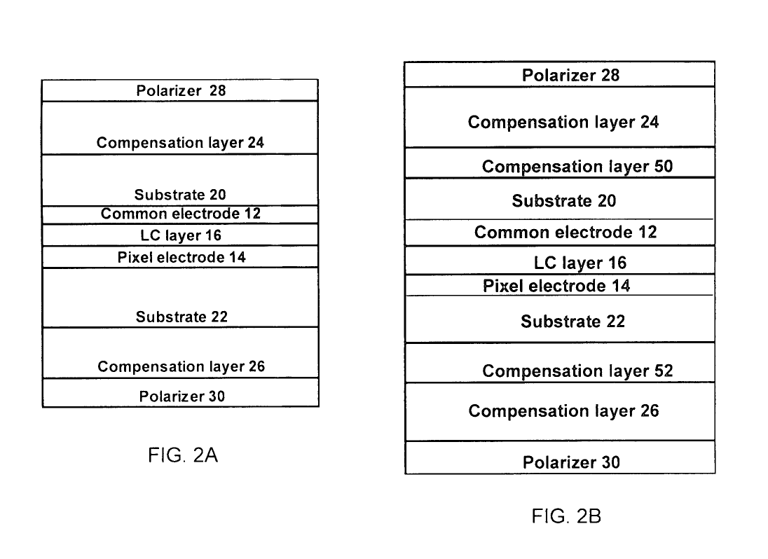

In some embodiments, LCD 10 of the invention includes first-type optical compensation layers 24 and 26, as shown in FIG. 2A. In other embodiments, LCD 10 of the invention further includes at least one second-type optical compensation layer between either first-type optical compensation layer 24 or 26, and LC layer 16. Shown in FIG. 2B is LCD 10 of the invention, employing second-type optical compensation layer 50 between first-type optical compensation layer 24 and LC layer 16, and second-type optical compensation layer 52 between first-type optical compensation layer 26 and LC layer 16.

In one specific embodiment, second-type optical compensation layers 50 and 52 each independently include a material having negative birefrinoence. Preferably. in this embodiment, LC material 18 has positive birefringence. The optical axis of second-type compensation layer 50 or 52 can be substantially normal to, or tilted from a plane of first substrate 20 or second substrate 22 throughout the thickness of the layer.

Alternatively, the optical axis of second-type compensation layer 50 or 52 can be varied along the thickness of the layer (i.e., an inhomogeneous material).

In another specific embodiment, second-type optical compensation layers 50 and 52 each independently include a material having positive birefringence. Preferably, in this embodiment, LC material 18 has negative birefringence. The optical axis of second-type compensation layer 50 or 52 can be substantially parallel to, normal to, or tilted from a plane of first substrate 20 or second substrate 22 throughout the thickness of the layer. Alternatively, the optical axis of second-type compensation layer 50 or 52 can be varied along the thickness of the layer.

With respect to the optical axis of second-type optical compensation layer 50 or 52, the phrases “substantially parallel to a plane of first substrate 20 or second substrate 22,” “substantially normal to a plane of first substrate 20 or second substrate 22” and “substantially tilted from a plane of first substrate 20 or second substrate 22,” as used herein, mean that the optical axis is respectively parallel or normal to, and tilted from a plane of first substrate 20 or second substrate 22 with less than about 10-degree deviation. In a preferred embodiment, the optical axis of second-type compensation layer 50 or 52 is parallel or normal to, or tilted from a plane of substrate 20 or 22 with a deviation less than about 5-degree, such as less than about 3-degree or less than about 1-degree.

Specific examples of suitable second-type optical compensation layers 50 and 52 include those disclosed in H. Mori, et. al., SID 97 Digest, pp. 941-944 (1997); H. L. Ong, Japan Display '92, pp. 247-250 (1992); and J. P. Eblen, et. al. SID 94 Digest, pp. 245-248 (1994), all of which are incorporated herein by reference in entirety.

Any suitable compensation materials known in the art can be used in the first-type and second-type compensation lavers. respectively. For example. compensation materials disclosed in H Mori, et. al., Jpn. J. Appi. Phys. Vol. 36, pp. 143-147 (1997); H. Mori, et. al., SID 97 Digest, pp. 941-944 (1997); US 2005/0162592A1; U.S. Pat. Nos. 5,594,568; and 5,796,456, the entire teachings of which are incorporated herein by reference, can be used in the invention.

First-type optical compensation layers 24 and 26, and second-type optical compensation layers 50 and 52 can be fabricated by any suitable method known in the art, for example, in H Mori, et. al., Jpn. J Appl. Phys. Vol. 36, pp. 143-147 (1997); H. Mori, et. al., SID 97 Digest, pp. 941-944 (1997); US 2005/0162592A1; U.S. Pat. Nos. 5,594,568; and 5,796,456. In one example, the optical compensation layers can be prepared by coating a suitable material having negative birefringence on a film base or the like. The coating of the material can be carried out by a suitable method known in the art, such as spin coating, roller coating, flow coating, printing, dip coating, film flow-expanding, bar coating or gravure printing. Any suitable methods known in the art can be used for orienting the material so as to provide the desired optical axis orientation. For example, a solution containing the material is coated and subsequently dried for an orientation in the thickness direction. Alternatively, the material can be oriented through stretching, for example, by coating a solution of the material on a stretchable substrate base and stretching the base.

Electrodes 12 and 14 for the invention can be formed by, for example, any suitable method known in the art. For example, electrodes can be made from a poly-crystal silicon layer or transparent conductive material such as indium tin oxide, or other metal oxides such as titanium dioxide or zinc oxide. Conductive nitrides, such as aluminum nitride, for example, can also be used. Pixel electrode(s) 14 can be formed prior to transfer of a drive circuit for driving LCD 10 of the invention, such as an active matrix circuit, onto a transparent substrate. Alternatively, pixel electrode(s) 14 can be formed after transfer of the active matrix circuit onto a transparent substrate, and vias are formed through an insulating layer on which transistor circuits are formed to conductively connect pixel electrode(s) 14 to their respective switching transistors. This can permit pixel electrode(s) 14 to be fabricated over the transistor circuits. Typically, pixel electrode 14 has a thickness in a range of between about 10 nm and about 20 nm, and common electrode 12 has a thickness in a range of between about 50 nm and about 200 nm.

LC layer 16 includes LC material 18, preferably twisted-nematic LC material 18. In a preferred embodiment, LC material 18 has positive birefringence. In nematic LCs, the LC molecules have no positional order when there is no external magnetic or electric field, but they can be easily aligned by an external magnetic or electric field applied to them. Any suitable twisted nematic liquid crystal (LC) material 18 known in the art can be used in the invention. Various types of such LC materials are commercially available, for example, from Merck KGaA in Germany, such as MLC-9000-000, MLC-9000-100, MLC-9300-000, MLC-9300-100, and also from Chisso in Japan, such as ZOC-5057-LA, and ZOC-5058-LA.

LC layer 16 can further include alignment films. In some embodiments, the alignment films have different rubbing directions, e.g., 90-degree from each other. Examples of alignment materials for alignment films include polyimide (PI) materials, such as SE-7511L, SE-1211 and RN-1566, which are available from Japan Nissan Chemical Industrial Ltd. Other suitable vertical alignment materials are also available from JSR Corporation in Japan. The alignment layer can also be fabricated by a suitable method know in the art.

LC material 18 is typically positioned between substrates 20 and 22. Typically, the distance between the substrates 20 and 22 (or the thickness of LC layer 16), sandwiching LC material 18, is between about 1 μm and about 6 μm.

Any transparent substrates known in the art can be used for substrates 20 and 22 in the invention. Suitable examples of substrates 20 and 22 include glass, fused silica, sapphire and transparent plastics.

Polarizer layers 28 and 30 are positioned outside of first-type optical compensation layers 24 and 26, respectively. Polarizer layers 28 and 30 are disposed in either a crossed (e.g., normally white LCD) or parallel geometry (e.g., normally black LCD). Any suitable polarizer materials known in the art can be used in the invention.

In a preferred embodiment, the LCD of the invention is an active matrix LCD, preferably equipped with a plurality of thin-film transistors (TFTs) in each pixel. Alternatively, the LCD of the invention can also be an active matrix LCD using MIMs (Metal-Insulator-Metal), or a passive matrix LCD. TFTs can be fabricated by any suitable method known in the art, for example, by the methods described in U.S. Pat. Nos. 5,206,749, 5,705,424 and 6,608,654, the entire teachings of which are incorporated herein by reference.

ICs (integrated circuits) known in the art can be employed as a drive circuit for driving the LCDs of the invention. Preferably, a CMOS (Complementary Metal-Oxide-Semiconductor) driver utilizing a single crystal silicon-on-insulator (SOI) starting material is employed in the invention. Such a CMOS can be driven by a dc common drive scheme or by an ac-coupled drive scheme, known in the art, for example, in Richard, A. and Herrmann, F. P., “A New Drive Scheme Architecture for AMLCDs Used in Microdisplays,” Information Display, pp 14-17 (2005), the entire teachings of which are incorporated herein by reference. For example, the CMOS can be driven by an ac-coupled drive scheme.

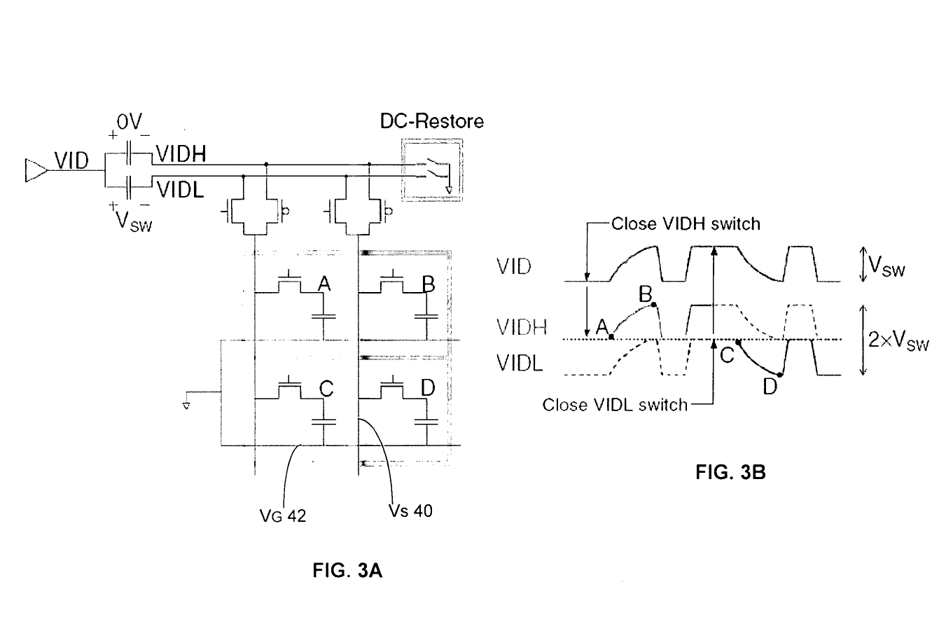

An example of ac-coupled drive schemes that can be used in the invention is shown in FIG. 3A. As shown in FIG. 3A, a single amplifier drives a source signal (identified in FIG. 3A as “VID”) with a swing of 1×Vsw. Two external capacitors couple the VID signal to the display input signals (identified in FIG. 3A as “VIDH” and “VIDL”). As shown in FIG. 3A, two video input pins are employed. Also, CMOS column drivers are split; the p-channel transistor is connected to VIDH and the n-channel transistor is connected to VIDL. Only one transistor of the pair is activated at a time. The dc-restore switches shown in FIG. 3A are preferably added to maintain the desired voltages across the coupling capacitors. FIG. 3B is a timing diagram that illustrates operation of the ac-coupled drive scheme of FIG. 3A. For example, the VID signal is kept low at the beginning of the first row, while the dc-restore switch for VIDH is closed briefly to set 0 V across the VTDH coupling capacitor. Dots A and B are written to white (e.g., light passes through the LCD display and color can be viewed) and black (e.g., light does not pass through the LCD display) using the p-channel column-drive transistors. The polarity of VID is inverted before the second row is written, so VID is held at high while the switch to VIDL is closed. This sets the VIDH capacitor voltage to Vsw. The n-channel column drivers are then activated to write dot C to white and dot D to black with −Vsw, as shown in FIG. 3B. The VID polarity is switched again at the end of the row, in preparation for the dc restore of VIDH.

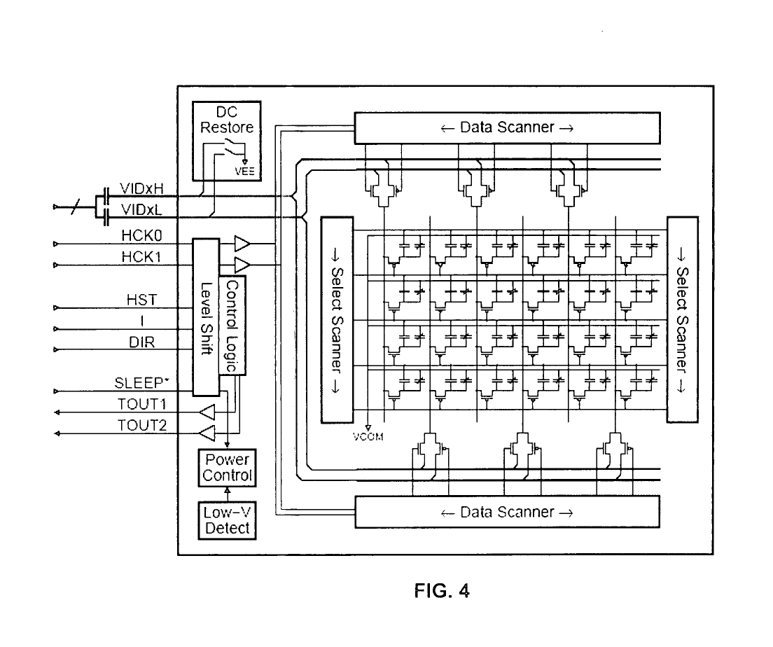

Referring to FIG. 4, the block diagram corresponds to an LCD of the invention. In FIG. 4, external capacitors couple 16 video signals to the display's 32 video inputs. Integrated scanners drive the pixel array. Two bi-directional horizontal data scanners switch the video inputs onto the column lines. The bi-directional vertical scanners select rows one by one, driving from both ends of each row line. The input level shift circuits accept digital control signals with, e.g., 3.3-volt levels. An internal power down reset circuit can be used to equalize charge in the pixel array before power is removed from the display to prevent image retention and/or flicker upon restoration of power. An internal heater can also be integrated into the display to support a warm up mode. During the warm up mode, current flows from one vertical scanner across the display through, e.g., a resistive polysilicon row lines to another vertical scanner.

In some preferred embodiments, the LCDs of the invention include one or more backlight sources. Any suitable backlight sources known in the art can be used in the invention. In a preferred embodiment, the LCDs of the invention include a plurality of LED sources, such as red, green and blue LED sources. In a more preferred embodiment, the displays of the invention further include one or more diffusers and/or one or more brightness enhancement films. Suitable examples of diffusers include USA 3M, Japan Omron and Nitto Denko. Suitable examples of brightness enhancement films include USA 3M and Japan Nitto Denko.

The LCDs of the invention can be transmissive-type LCDs, reflective-type LCDs, or transflective-type LCDs. In a preferred embodiment, the LCDs of the invention are TN LCDs with various twisted angles, including 90°. Also, the LCDs of the invention can be multi-domain TN LCDs. The LCDs of the invention can be black and white TN LCDs or, alternatively, color TN LCDs. In color TN LCDs, at least one color filter of each of red, blue and green can be included.

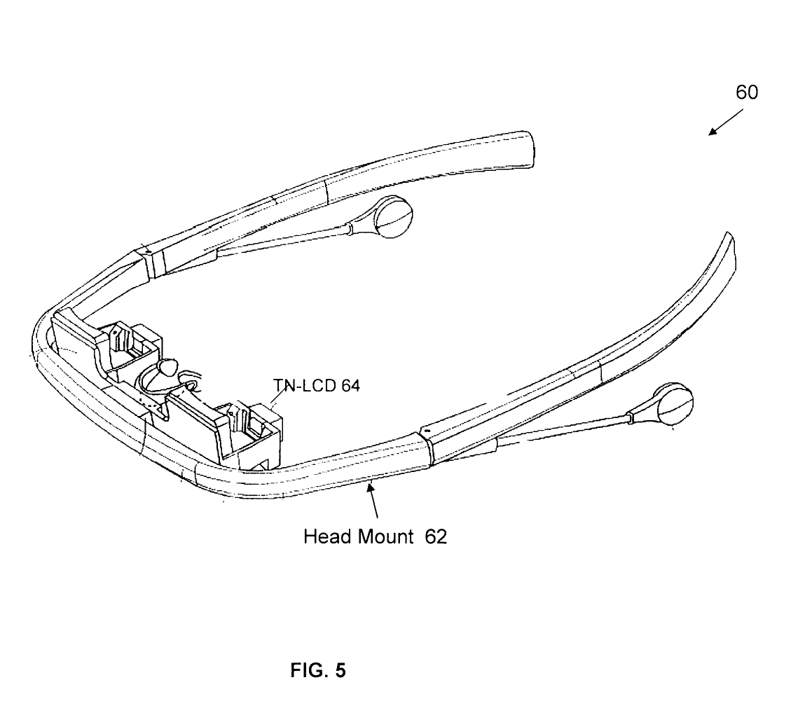

In a preferred embodiment, the LCDs of the invention are head-mounted displays, employing head mounts as described in U.S. Pat. Nos. 5,815,126; 6,452,572; 6,421,031; 6,448,944 and 6,424,321, the entire teachings of which are incorporated herein by reference. Head-mounted display 60 of the invention is shown in FIG. 5, including head mount 62 and LCD 64 of the invention.

In another preferred embodiment, the LCDs of the invention has an active matrix display that includes a plurality of pixel electrodes and thin-film pixel transistors. In an even preferred embodiment, the LCDs of the invention have a display area of at least 320×240 pixels, such as at least 640×480 pixels, at least 800×600 pixels, or at least 1280×1024 pixels. In en even more preferred embodiment, the LCDs of the invention are head-mounted displays having a display area of at least 320×240 pixels, such as at least 640×480 pixels, at least 800×600 pixels, or at least 1280×1024 pixels.

The LCDs of the invention can be fabricated by any suitable methods known in the art. For example, color filters are printed onto one of glass or plastic transparent substrates. Thin layers of electrode material(s), such as indium tin oxide (ITO) onto the substrates to form electrodes. A layer of alignment material such as polyimide is deposited onto the substrates. One or more spacers are placed between the substrates, and the edges of the substrates are sealed. LC molecules are placed into the gap between the substrates by capillary action or vacuum injection. Optical compensation layers and polarizer layers are placed on both sides of the display.

The active matrix transistor circuits and pixel electrodes of the LCDs of the invention can be made by any suitable methods known in the art, for example by the methods disclosed in U.S. Pat. Nos. 5,206,749, 5,705,424 and 6,608,654, the entire teachings of which are incorporated herein by reference. In one embodiment, the active matrix transistor circuits are made by the methods described in U.S. Pat. No. 5,206,749. As described in U.S. Pat. No. 5,206,749, the active matrix transistor circuits are formed in a single crystal Si material having a silicon-on-insulator (SOI) structure. The SOI structure can be fabricated using a number of techniques, including recrystallization of non-single crystal Si that has been deposited on a silicon dioxide layer formed on a single crystal Si substrate. This Si or other semiconductor substrate can be removed by etching, after bonding of the circuit to a transparent substrate. Other methods for SOI structure fabrication, including the bonding of two wafers with an adhesive and lapping of one wafer to from a thin film and transfer of the thin film onto glass, or, alternatively, by implantation of oxygen into a silicon wafer, can also be used.

In one example, as described in U.S. Pat. No. 5,705,424, active matrix circuits for electronic displays can be fabricated in thin film single crystal silicon and transferred onto glass substrates for display fabrication. A transistor in an active matrix circuit can be formed with a thin film single crystal silicon layer over an insulating substrate. The areas or regions of the circuit in which pixel electrodes are to be formed are subjected to a silicon etch to expose the underlying oxide. A transparent conductive pixel electrode is then formed on or over the exposed oxide with a portion of the deposited electrode extending up the transistor sidewall to the contact metalization of the transistor. A passivation layer is then formed over the entire device, which is then transferred to an optically transparent substrate. The composite structure is then attached to a common electrode and polarization elements and an LC material are then inserted into the cavity formed between the oxide layer and the common electrode.

In another example, fabrication of active matrix pixel electrodes can be done after transfer of the active matrix circuit onto a transparent substrate and exposure of the backside of the insulator on which a thin film single crystal silicon was formed, as described in U.S. Pat. No. 5,705,424. In this process, a transferred active matrix circuit is prepared. Vias are formed through the insulator to expose a contact area of the silicon in the transistor circuit. A conductive transparent electrode material is then deposited and patterned to make electrical contact to the transistor circuit through the vias and simultaneously form the pixel electrodes. An additional metal layer or other conductive material can be formed between the electrode material and the contact area to improve conductivity. A separate light shield region can also be formed on the second side of the circuit.

### EXEMPLIFICATION

### Example

Contrast Ratio Calculation to Generate Simulated Results

The contrast ratio of the TN LCDs of the invention can be modeled with both two-dimensional and thee-dimensional models, such as Autronic 2-D LC Modeling software (2-D modeling) and Shintech 3-D LC Modeling software (3-D modeling). Geometrical optics approximation can be used for such modeling to make a fast estimation on the TN LCD electrical optical transmission. The contrast ratio improvement of the LCDs of the invention can arise from the shift of the contrast ratio peak from off-normal incidence to close to normal incidence, without or minimal loss of contrast ratio peak.

A standard 90-degree TN cell with a cell gap of 2.2 μm and LC ZOC-5057LA available from Chisso Corporation as an LC material are considered in the calculations below. The pretilt angle is 20-degrees. In the calculation, optical compensation layers 24 and 26, having nₒ=1.51, nₑ=1.50, and layer thickness d=10 nm to 200 nm are considered. The optical retardation of such optical compensation layers 24 and 26 is then in a range of between −1 nm and −20 nm.

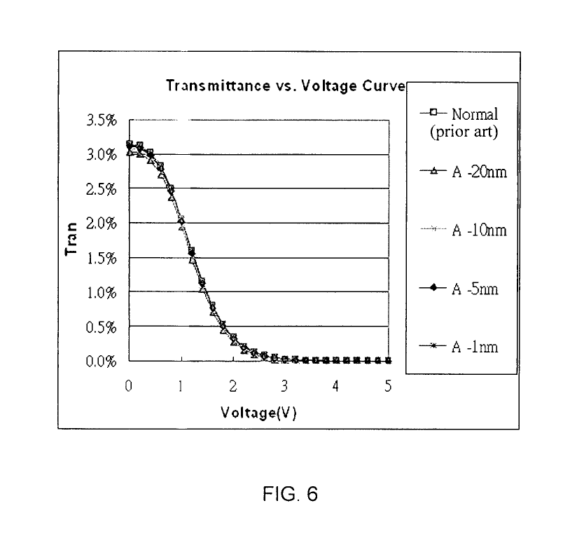

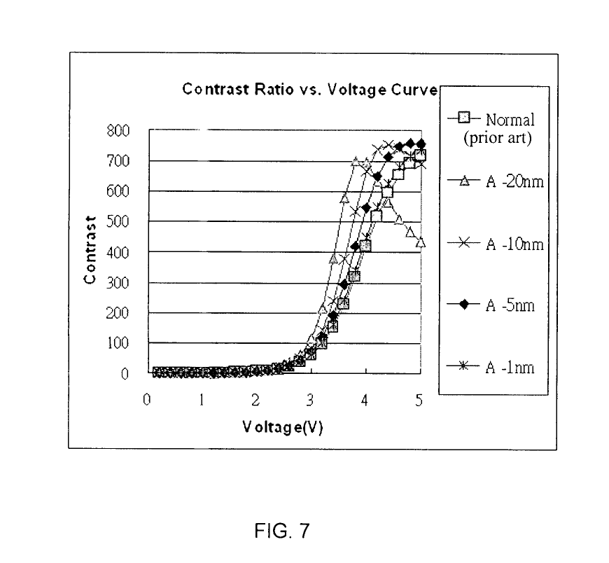

FIGS. 6 and 7 show calculated normal-incident optical transmission and contrast ratio versus voltage for TN LCDs with and without first-type optical compensation layers 24 and 26 to simulate one embodiment of the invention. The calculated optical retardation of four tested TN LCDs of the invention, having first-type optical compensation layers 24 and 26, was respectively −1, −5, −10 and −20 nm. The TN LCDs of the invention and the control TN LCDs without such optical compensation layers wvere all under a crossed-polarizer geometry. The results shoved that the optical transmission of all four TN LCDs of the invention with different retardation values was similar with each other at various applies voltages. lhowever, their contrast ratios were significantly improved by compensation layers 24 and 26 at low applied voltage. For example, at 3.6 volts, for the TN LCD of the invention with a retardation of −20 nm, the calculated contrast ratio was 700, whereas the calculated contrast ratio of the control TN LCD.

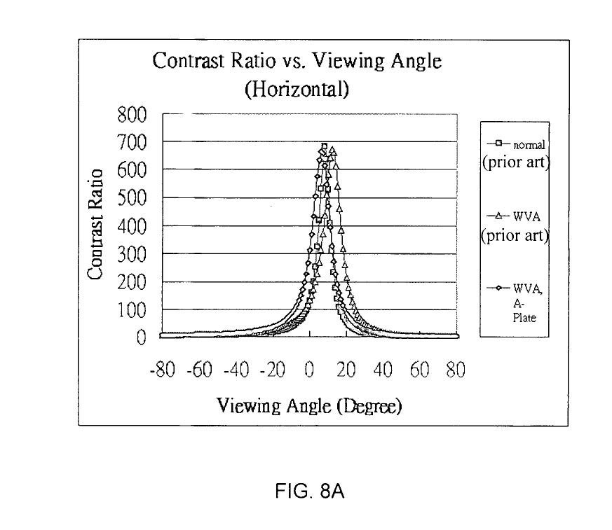

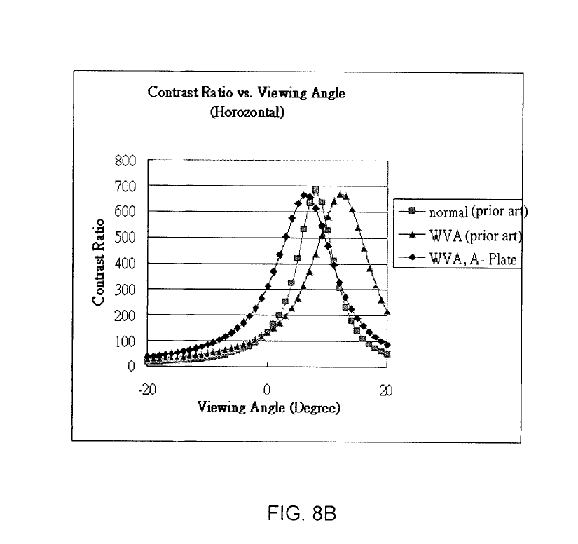

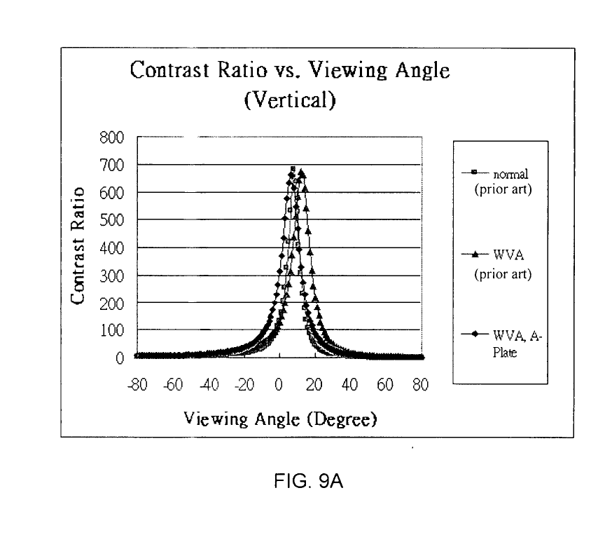

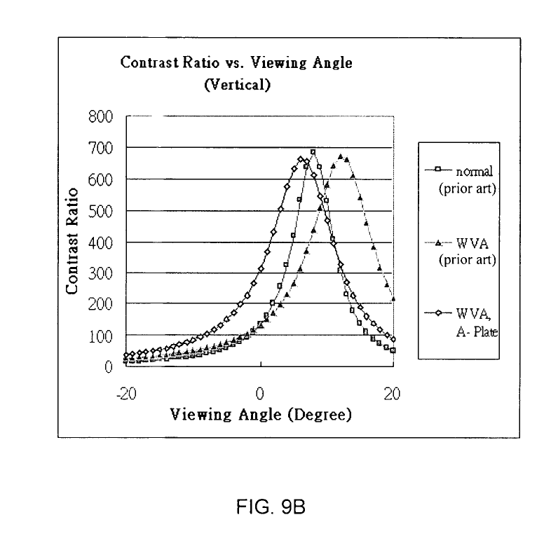

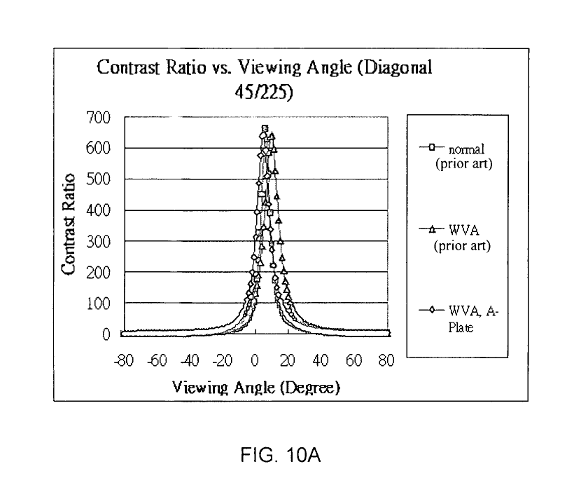

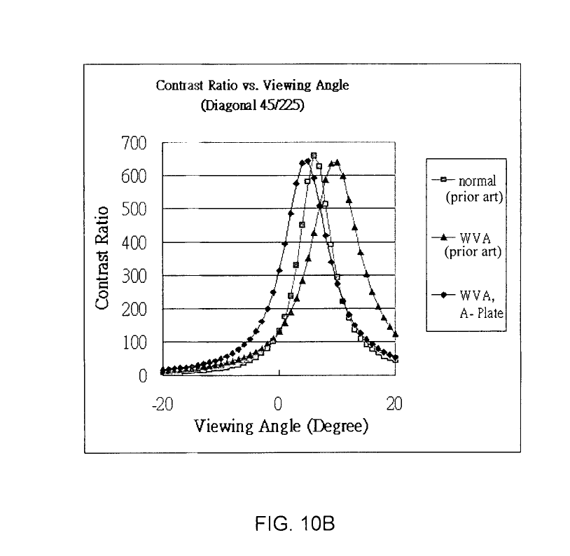

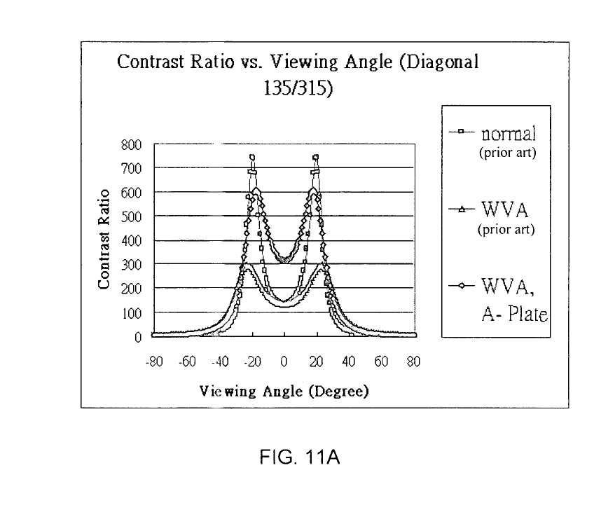

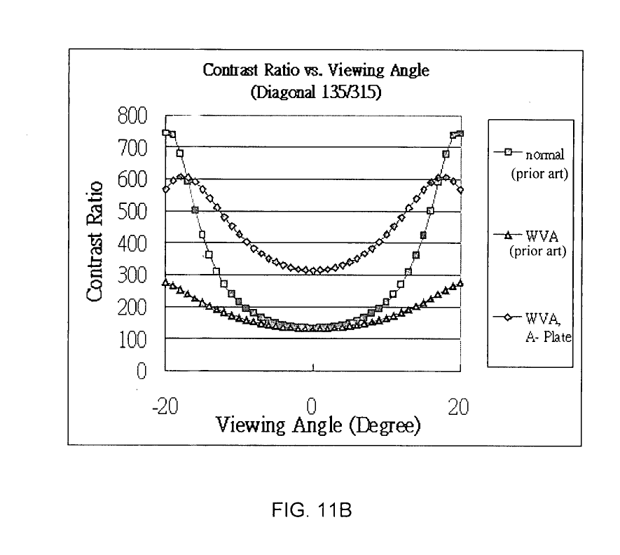

With the combination of first-type optical compensation layers 24 and 26, and conventional, wide-viewing-angle compensation layers available from FujiFilm, the contrast ratio and viewing angle with a low applied voltage could be improved. FIGS. 8A-11B show calculated contrast ratio versus viewing angle for various viewing angle zones at an applied voltage of 3.1 volts in TN LCDs with this combination. The results show that this combination can enlarge the viewing angle of the TN LCDs.

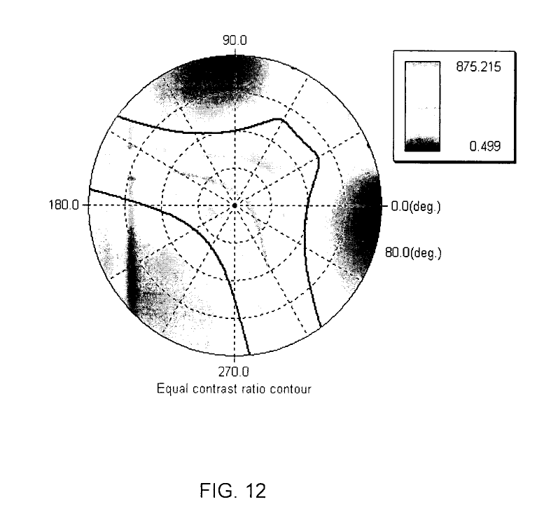

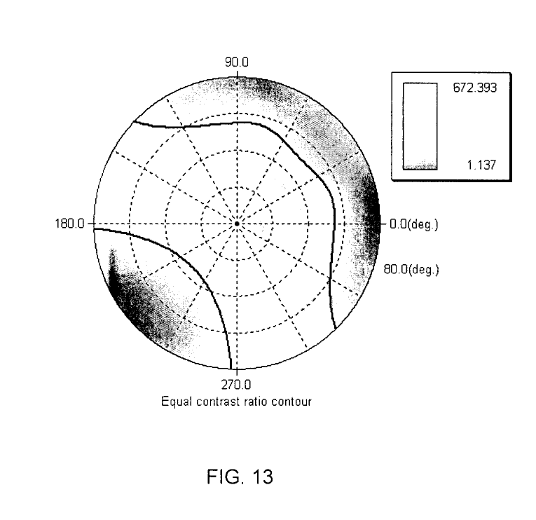

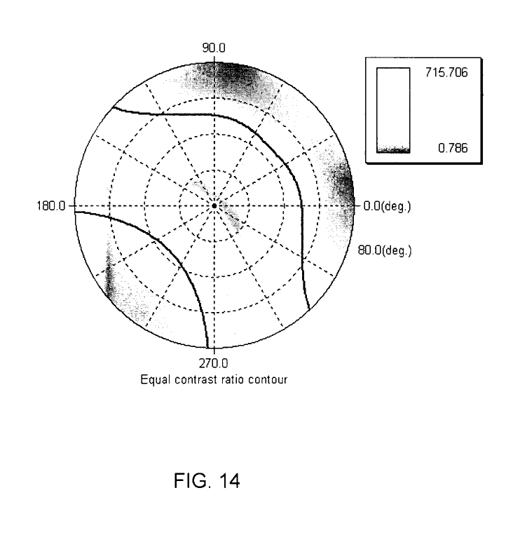

FIGS. 12-14 show calculated contrast ratio contour plots for TN LCDs without first-type compensation layers 24 and 26 (FIG. 12), with first-type compensation layers 24 and 26 (FIG. 13) and with both first-type compensation layers 24 and 26 and the conventional, wide-viewing-angle compensation layers available from Fuji Photo Film Co. (FIG. 14). As shown in FIG. 13 and 14 compared to FIG. 12, large viewing angles can be obtained in the TN LCDs of the invention.

### EQUIVALENTS

While this invention has been particularly shown and described with references to preferred embodiments thereof, it will be understood by those skilled in the art that various changes in form and details may be made therein without departing from the scope of the invention encompassed by the appended claims.

What is claimed is:

1. A liquid crystal display, comprising:
a) a liquid crystal layer between a first substrate and a second substrate, the liquid crystal layer having a birefringence liquid crystal material;
b) at least one first-type optical compensation layer over the liquid crystal layer, wherein the first-type optical compensation layer includes a negative birefringence material, wherein the optical axis of the first-type optical compensation layer is substantially parallel to a plane of either the first substrate or the second substrate throughout the first-type optical compensation layer; and
c) at least one polarizer layer over the first-type optical compensation layer.

2. The liquid crystal display of claim 1, further includes a common electrode between the first substrate and the liquid crystal layer, and a plurality pixel electrodes between the second substrate and the liquid crystal layer.

3. The liquid crystal display of claim 1, wherein the optical compensation layer has an optical retardation value of between about −1 nm and about −50 nm.

4. The liquid crystal display of claim 1, further including at least one second-type optical compensation layer that includes a material having negative birefringence and has an optical axis normal, to or tilted from the plane of wither the first substrate or the second substrate throughout the second-type optical compensation layer, the second-type optical compensation layer being between the first-type optical compensation layer and the liquid crystal layer.

5. The liquid crystal display of claim 4, wherein the optical axis of the second-type optical compensation layer is tilted and varies along the thickness of the layer.

6. The liquid crystal display of claim 2, wherein the display includes a display area of at least 320×240 pixels.

7. The liquid crystal display of claim 1, wherein the display is head mountable.

8. A method of preparing a liquid crystal display, comprising the steps of:
a) forming a liquid crystal layer between a first substrate and a second substrate, the liquid crystal layer having a birefringence liquid crystal material;
b) forming at least one first-type optical compensation layer over the liquid crystal layer, wherein the first-type optical compensation layer includes a negative birefringence material, wherein the optical axis of the first-type optical compensation layer is substantially parallel to a plane of either the first substrate or the second substrate throughout the first-type optical compensation layer; and
c) forming at least one polarizer layer over the liquid crystal layer.

9. The method of claim 8, further including the steps of: a) forming a common electrode between the first substrate and the liquid crystal layer; and b) forming a plurality of pixel electrodes between the second substrate and the liquid crystal layer.

10. The method of claim 9, wherein the display includes a display area of at least 320×240 pixels.

11. The method of claim 8, further including the step of forming at least one second-type optical compensation layer between the first-type optical compensation layer and the liquid crystal layer, wherein the second-type optical compensation layer includes a material having negative birefringence and has an optical axis normal to, or tilted from the plane of either the first substrate or the second substrate throughout the second-type optical compensation layer.

12. The method of claim 11, wherein the optical axis of the second-type optical compensation layer is tilted and varies along the thickness of the layer.

13. The method of claim 8, wherein the optical compensation layer has an optical retardation value of between about −1 nm and about −50 nm.

14. The method of claim 8, wherein the display is head mountable.
